(19) United States
(12) Patent Application Publication
(10) Pub. No.: US 2012/0014246 A1
(43) Pub. Date: Jan. 19, 2012

(54) METHOD AND SYSTEM FOR SETTING UP PATH THROUGH AUTONOMOUS DISTRIBUTED CONTROL, AND COMMUNICATION DEVICE

(76) Inventors: Takehiko Matsumoto, Tokyo (JP); Toru Nakazawa, Tokyo (JP); Shunji Motomura, Tokyo (JP)

(21) Appl. No.: 13/258,877

(22) PCT Filed: Mar. 15, 2010
(86) PCT No.: PCT/JP2010/001819

§ 371 Date: Sep. 22, 2011

(30) Foreign Application Priority Data
Mar. 23, 2009 (JP) 2009-070980

(51) Int. Cl. H04L 12/26

(52) U.S. Cl. 370/221

(57) ABSTRACT

A path setup method that makes it possible to avoid a failure in path setup even if a state when setting up a path is that a communication device existing in the path is incapable of communication, as well as a communication device using the method, are provided. According to a method for setting up a path through autonomous distributed control in a network in which a plurality of communication devices (NE200 to NE206) are connected, a communication device (NE201) determines whether or not it is possible to communicate with a communication device (NE203) neighboring to the communication device and, if a state is that it is impossible to communicate with the neighboring communication device, converts signaling for setting up a path (P1) passing through the neighboring communication device into signaling for setting a provisional path (P2) detouring around the neighboring communication device.

### TECHNICAL FIELD

The present invention relates to a path setup method and system in an autonomous distributed control-based network, as well as a communication device using the same.

### BACKGROUND ART

A variety of autonomous distribution-type path setup and operation technologies are provided, such as MPLS (Multi-Protocol Label Switching), GMPLS (Generalized MPLS), or application of GMPLS to ASON (Automatically Switched Optical Network). In such autonomous distributed control-based networks, there are some cases where the need to restart a communication device arises for some reason such as a fault in a control channel or in the communication device itself, or device maintenance.

RFC 5063, which is NPL 1, is defined as standard specifications for recovery of the state of a path previous to restart when a communication device is restarted for some reason as described above. Moreover, PTL 1 proposes a technology for protecting traffic from a fault by computing beforehand an alternative path across an all-optical network.

### [Citation List]

### [Patent Literature]

### [PTL 1]

### Japanese Patent Application Unexamined Publication No. 2006-80778.

### [Non Patent Literature]

### [NPL 1]

### RFC 5063 (Extensions to GMPLS Resource Reservation Protocol (RSVP) Graceful Restart), October 2007

### SUMMARY OF INVENTION

### Technical Problem

However, when a path is set up by Explicit Route Object (ERO) of an autonomous distributed control protocol, the setup of a path will fail if a communication device receives path setup signaling in a state where it is impossible to communicate with a neighboring communication device with which the path is to be set up.

According to the method described in NPL 1, a path already set up prior to restart is only recovered, and a case is not assumed where path setup signaling occurs when a communication device is restarting and is in a state incapable of communication. Moreover, according to the method disclosed in PTL 1, a path other than an initially set-up original path is computed beforehand as an alternative path. The method does not teach a method for setting up a path when path setup signaling arrives at a communication device that is restarting and is in a state incapable of communication.

An object of the present invention is to provide a path setup method and system as well as a communication device using the path setup method, that make it possible to avoid a failure in path setup even if a communication device existing in a path to be set up is incapable of communication.

### Solution to Problem

A path setup method according to the present invention is a method for setting up a path through autonomous distributed control in a network in which a plurality of communication devices are connected, characterized by comprising: by a communication device, determining whether or not it is possible to communicate with a neighboring communication device neighboring to the communication device; and when it is impossible to communicate with the neighboring communication device, converting signaling for setting up a path passing through the neighboring communication device into signaling for setting up a provisional path detouring around the neighboring communication device.

A communication device according to the present invention is a communication device which is connected to a plurality of neighboring communication devices and has a function of setting up a path through autonomous distributed control, characterized by comprising: determination means that determines whether or not it is possible to communicate with a neighboring communication device; and signaling conversion means that, when it is impossible to communicate with the neighboring communication device, converts signaling for setting up a path passing through the neighboring communication device into signaling for setting up a provisional path detouring around the neighboring communication device.

A path setup system according to the present invention is a system for setting up a path through autonomous distributed control in a network in which a plurality of communication devices are connected, characterized in that each of the plurality of communication devices comprises: determination means that determines whether or not it is possible to communicate with a neighboring communication device; and signaling conversion means that, when it is impossible to communicate with the neighboring communication device, converts signaling for setting up a path passing through the neighboring communication device into signaling for setting up a provisional path detouring around the neighboring communication device.

A computer program according to the present invention is a computer program causing a program-controlled processor to implement a function that is connected to a plurality of neighboring communication devices and sets up a path through autonomous distributed control, characterized by causing the program-controlled processor to implement a determination function of determining whether or not it is possible to communicate with a neighboring communication device, and a signaling conversion function of, when it is impossible to communicate with the neighboring communication device, converting signaling for setting up a path passing through the neighboring communication device into signaling for setting up a provisional path detouring around the neighboring communication device.

### Advantageous Effects of Invention

According to the present invention, it is possible to avoid a failure in path setup even if a communication device existing in a path to be set up is incapable of communication.

### BRIEF DESCRIPTION OF DRAWINGS

FIG. 1 is a network structure diagram for describing a path setup method according to an embodiment of the present invention.

FIG. 2A is a network structure diagram for describing a restart initiation notification procedure in a path setup method according to a first example of the present invention, and FIG. 2B is a network structure diagram for describing a provisional path setup procedure in the path setup method according to the first example.

FIG. 3 is a network structure diagram for describing a restart completion notification procedure in the path setup method according to the first example.

FIG. 4 is a network structure diagram for describing a provisional path disconnection and permanent path setup procedure in the path setup method according to the first example.

FIG. 5 is a network structure diagram showing an example of a network for implementing the path setup method according to the first example.

FIG. 6 is a block diagram showing a configuration of a communication device according to the first example.

FIG. 7 is a diagram showing an example of a path management table stored in a path management information storage section in FIG. 6.

FIG. 8 is a format diagram showing an example of a path setup signaling message or path setup request used in the first example.

FIG. 9A is a format diagram showing an example of a path setup signaling message or path setup request for setting up a permanent path in the first example, and FIG. 9B is a format diagram showing an example of a path setup signaling message or path setup request for setting up a provisional path in the first example

FIG. 10 is a flowchart showing the entire procedure of the path setup method according to the first example.

FIG. 11 is a flowchart showing restart initiation processing in FIG. 10.

FIG. 12 is a flowchart showing provisional path setup processing in FIG. 10.

FIG. 13 is a flowchart showing permanent path setup and provisional path disconnection processing performed after restart is completed in FIG. 10.

FIG. 14A is a network structure diagram for describing a neighboring communication device state determination procedure in a path setup method according to a second example of the present invention, and FIG. 19B is a network structure diagram for describing a provisional path setup procedure in the path setup method according to the second example.

### DESCRIPTION OF EMBODIMENTS

### 1. Embodiment

A path setup method and system according to an embodiment of the present invention can make it possible that a path is successfully set up even if a communication device or node (hereinafter, abbreviated as NE where appropriate) with which the path is set up is in a state incapable of communication.

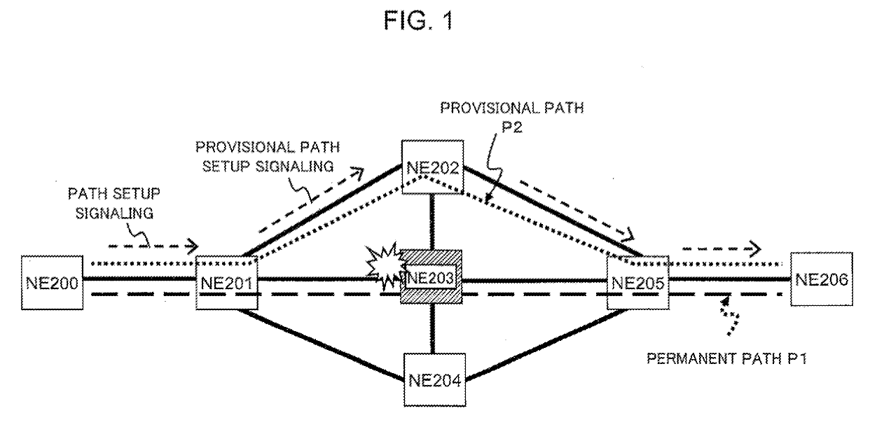

Hereinafter, the path setup method for a communication device according to the present embodiment will be described, assuming a simple network to avoid complicating the description. Here, assumed is a network in which seven communication devices NE200 to NE206 are connected as shown in FIG. 1, and considered is a case where NE 203, as an arbitrary NE of them, is in a state incapable of communication for some reason, when signaling occurs for setting up a path passing through this NE203 between NE200 and NE206. Note that this network structure is an example, and it is also a mere assumption to describe the present embodiment that NE203 in the network is suffering a fault or is restarting. The present invention can be applied to a network of any type in which a plurality of nodes or communication devices are connected.

As shown in FIG. 1, it is assumed that the communication device NE201 has recognized that it cannot communicate with the neighboring communication device NE203. This state incapable of communication can be recognized by detecting a restart initiation notification from the communication device NE203, a fault in the communication device NE203 itself, a fault in a channel between the communication devices NE201 and NE203, or the like.

In the state incapable of communicating at least with the communication device NE203 as described above, it is assumed that the communication device NE201 has received a signaling message for setting up a path including the communication device NE203 within the route (hereinafter, referred to as permanent path ply from the communication device NE200; which is the starting point node. In this case, the communication device NE201 according to the present embodiment initiates an operation for setting up an alternative path (hereinafter, referred to as provisional path P2) in place of the permanent path P1.

The communication device NE201, upon receipt of the path setup signaling message, converts this message into a provisional path setup signaling message for setting up the provisional path P2 detouring around the communication device NE203 and sends it to a communication device (here, NE202) in the detour direction. The provisional path setup signaling message is sequentially transferred to the communication devices NE202, NE205, and NE206, whereby the provisional path P2 is set up from NE200 to NE206 via NE202. Thus, even if the communication device NE203 existing in the original route of the path to be set up is in a state incapable of communication, the provisional path P2 is set up, whereby a failure in the path setup initiated by the path setup signaling can be avoided.

When recovery of the communication device NE203 is recognized after the provisional path P2 is set up, the communication device NE201 sends a signaling message for setting up the original permanent path P1 to the communication device NE203 that has recovered and also sends a signaling message for disconnecting the provisional path P2 to the communication device NE202. The permanent path setup signaling message is transferred from the communication device NE203 to NE205, whereby the permanent path P1 from the communication device NE200 to NE206 is set up, while the provisional path disconnection signaling message is transferred from the communication device NE202 to NE205, whereby the provisional path P2 is disconnected.

As described above, according to the present embodiment, when path setup signaling occurs in a state where a communication device cannot communicate with a neighboring communication device, the communication device initiates provisional path setup signaling for setting up the provisional path P2 detouring around the neighboring communication device incapable of communication, thereby setting up the provisional path P2. When the neighboring communication device is recovered, the permanent path P1 is set up, and a switch is made from the provisional path P2 to the permanent path P1. Thus, even if a state when setting up a path is that a communication device existing in the path is incapable of communication, it is possible to avoid a failure in path setup, and it is possible to return to the original path when restart is completed.

### 2. First Example

A path setup method and system according to a first example of the present invention is applied to a network based on autonomous distributed control such as GMPLS/ASON and make it possible that a path is successfully set up even when a communication device NE with which the path is to be set up is restarting.

First, a brief description will be given of terms used in a network based on autonomous distributed control such as GMPLS/ASON.

A path that is set up in this network is called LSP (Label Switched Path), and nodes existing along the route of a LSP are, from the upstream, a starting point node, a middle node, and an ending point node. In RSVP-TE (Resource ReSerVation Protocol-Traffic Engineering), the starting point node, middle node, and ending point node are also called Ingress, Transit, and Egress, respectively. Anode can serve as a starting point node, middle node, or an ending point node depending on a path to be set up even if the node is physically the same one.

A message for requesting LSP setup is called LSP Setup. A starting point node sends the message, and a downstream node reserves a band for the message and further sends the message downstream. This message is called Path Message in RSVP-TE Protocol Message.

A message for notifying acceptance of LSP reservation is called LSP Accept. An ending point node that has received LSP Setup sends this message toward upstream. This message is called Resv Message in RSVP-TE Protocol Message.

Path identification information is provided for identifying a path already set up or to be set up through autonomous distributed control. Generally, in GMPLS, a path existing on a network or a path to be set up can be uniquely identified by using the identifier of the starting point node of the path, the identifier of the ending point node thereof, and a path identifier, which each node keeps.

Path setup signaling is to exchange LSP Setup and LSP Accept messages between nodes in order to set up a path through autonomous distributed control. Transfer of LSP Setup from a starting point node to an ending point node is called LSP Setup signaling, and transfer of LSP Accept from an ending point node to a standing point node is called LSP Accept signaling. Note that LSP Accept signaling includes execution of channel setup that implements path setup processing such as communication interface hardware setup and control software band reservation for optical line continuity.

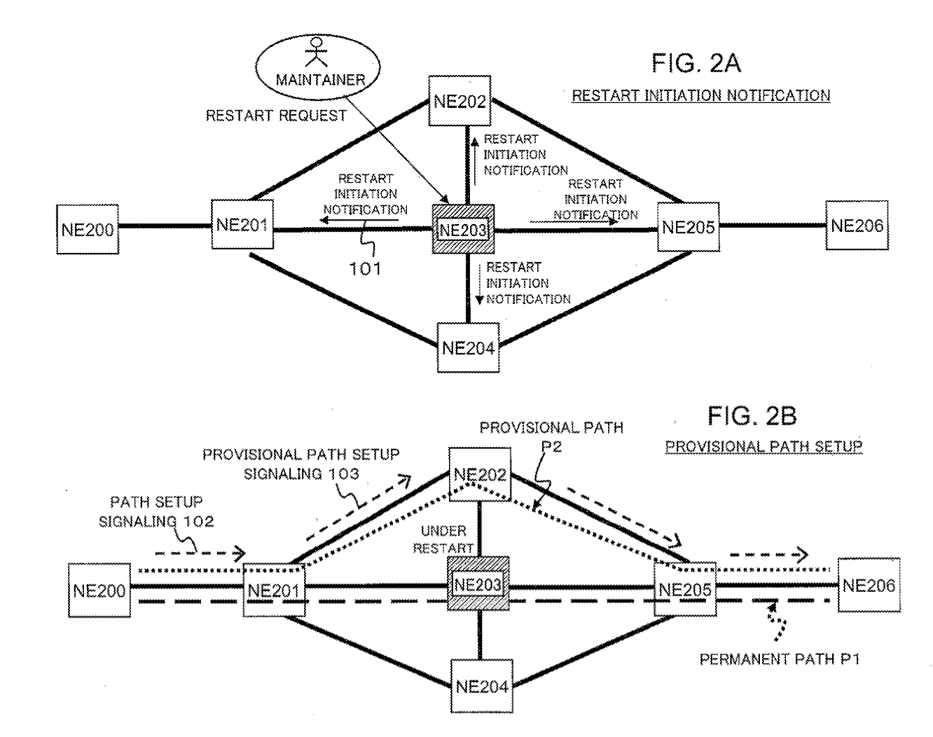

As shown in FIG. 2A, it is assumed that a maintainer requests a communication device NE203 to restart. The communication device NE203 requested to restart sends a restart initiation notification 101 to all neighboring communication devices (here, NE201, NE202, NE204, and NE205). The neighboring communication devices receive the restart initiation notification, thereby recognizing that NE203 is going to restart. After sending the restart initiation notification 101, the communication device NE203 initiates restarting.

In a state where the communication device NE203 is restarting as described above, it is assumed that a signaling message 102 for setting up a path including this communication device NE203 in the route (hereinafter, referred to as permanent path P1) has arrived at the communication device NE201. In this case, the communication device NE201 according to the present embodiment initiates an operation for setting up an alternative path (hereinafter, referred to as provisional path P2) in place of the permanent path Pl, as shown in FIG. 2B.

The communication device NE201, upon receipt of the path setup signaling message 102, converts the message into a provisional path setup signaling message 103 for setting up the provisional path P2 detouring around the communication device NE203 and sends it to a communication device (here, NE202) in the detour direction. The provisional path setup signaling message 103 is sequentially transferred to the communication devices NE202, NE205, and NE206, whereby the provisional path P2 from NE200 to NE206 via NE202 is set up. Thus, even if the communication device NE203 existing in the route of the original path to be set up is restarting, the provisional path P2 is set up, whereby it is possible to avoid a failure in the path setup initiated by the path setup signaling 102.

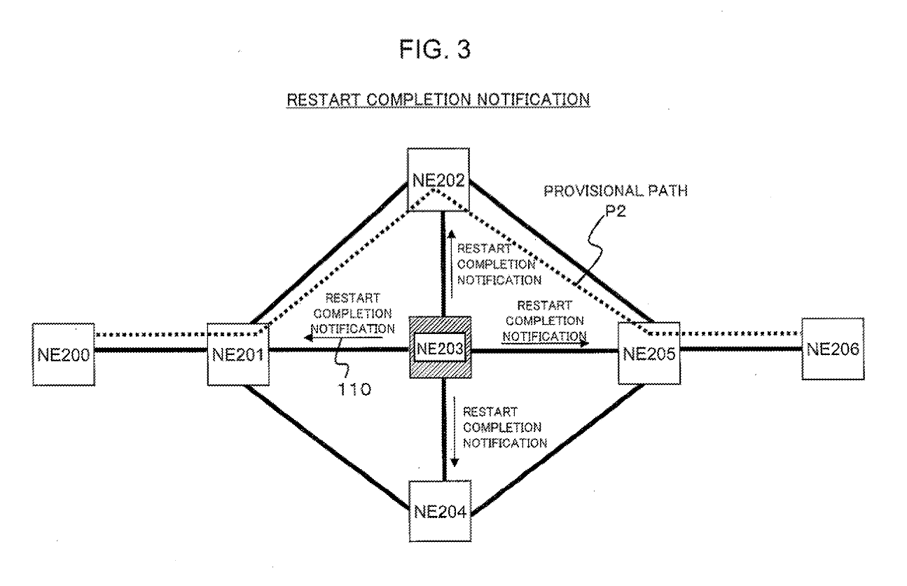

When the communication device NE203 has completed restart after the provisional path P2 is set up, the communication device NE203 sends a restart completion notification 110 to all the neighboring communication devices (here, NE201, NE202, NE204, and NE205), as shown in FIG. 3. The neighboring communication devices receive the restart completion notification, thereby recognizing that NE203 has completed restart.

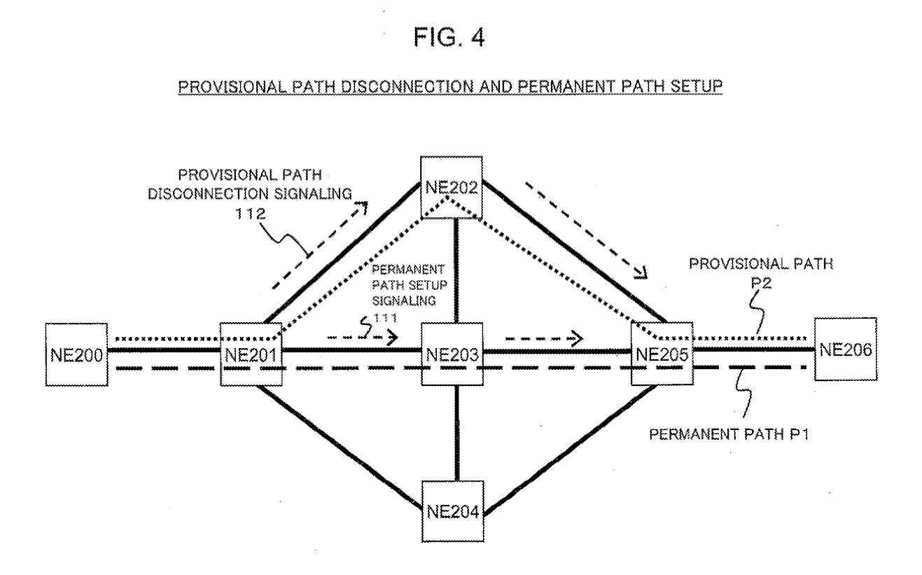

The communication device (here, NE201) that has received the restart completion notification initiates an operation for setting up the original permanent path P1 and disconnecting the provisional path P2, as shown in FIG. 4. Specifically, the communication device NE201 sends a signaling message 111 for setting up the permanent path P1 to the communication device NE203 that has completed restart, and also sends a signaling message 112 for disconnecting the provisional path P2 to the communication device NE202. The permanent path setup signaling message 111 is transferred from the communication device NE203 to NE205, whereby the permanent path P1 from the communication device NE200 to NE206 is set up, while the provisional path disconnection signaling message 112 is transferred from the communication device NE202 to NE205, whereby the provisional path P2 is disconnected.

As described above, according to the first example of the present invention, the provisional path P2 detouring around the restarting communication device NE203 is set up between the communication nodes NE201 and NE205, which neighbor to the restarting communication device NE203 on both sides thereof in the path setup direction. When restart is completed, a switch is made from the provisional path P2 to the permanent path P1. Thus, even if a communication device existing in a path is restarting when setting up the path, it is possible to avoid a failure in path setup, and it is possible to return to the original path when restart is completed.

### 2.1) System Structure

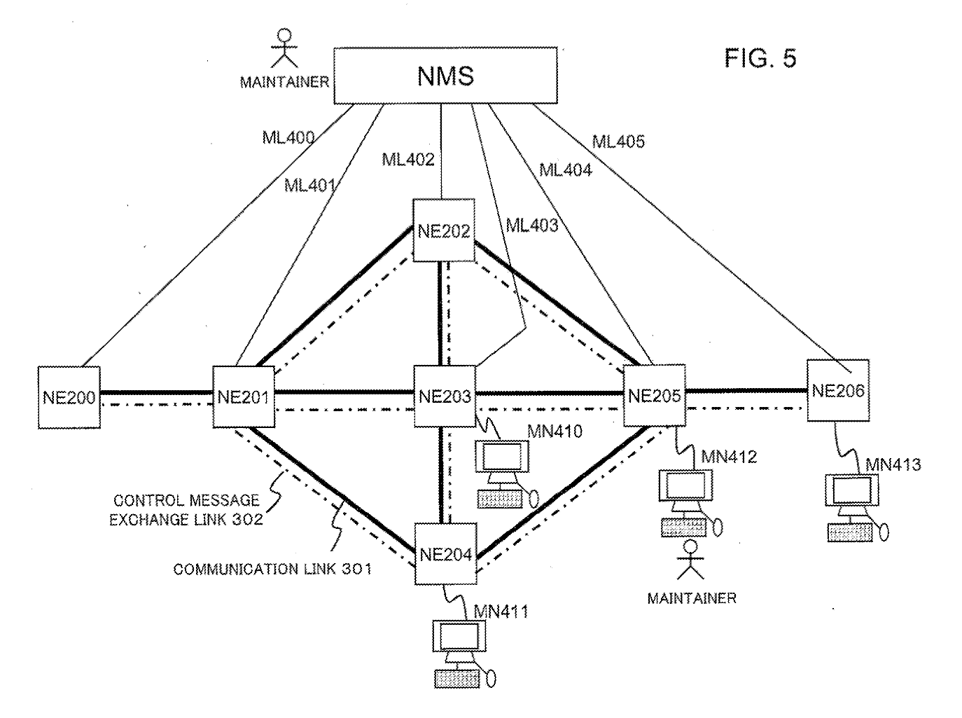

Referring to FIG. 5, the autonomous distributed control-based network includes a network management system NMS, communication devices NE200 to NE206 supporting autonomous distributed control such as GMPLS/ASON, and links connecting these system and devices. When setting up a path, each communication device (node) executes routing and signaling (LSP Setup signaling and LSP Accept signaling) through autonomous distributed control in accordance with an instruction from a maintainer, whereby a path between designated starting point and ending point communication devices can be set up or disconnected through label reservation and switch setup at each communication device.

In the network assumed in the present example, an end-to-end path is provided through communication technologies using packets, TDM (time division multiplexing), WDM (wavelength division multiplexing), and the like. Each of the communication devices NE200 to NE206 executes cross-connect (hereinafter, represented by XC) or switching based on label (identifier of a packet, timeslot, wavelength, or the like) information. Moreover, each of the communication devices NE200 to NE206 executes autonomous distributed control path routing and path management (setup/maintenance/disconnection of a path) in accordance with an autonomous distributed control protocol such as GMPLS/ASON.

Connection between the communication devices is made by a communication link 301 and a control message exchange link 302 through one optical fiber line or more. The communication link 301 is a link for transmitting user information, while the control message exchange link 302 is a link used to exchange control information between the communication devices. Depending on the network operation method, the communication link and control message exchange link can share a single physical link.

The network management system NMS has a function of monitoring and maintaining the communication devices in the entire network (for example, request for path setup/disconnection, removal and management of communication devices, and the like) and is a system serving as an interface between a maintainer and the network. NMS is connected to the communication devices NE200 to NE206 through management links ML400 to ML406, respectively, and can make settings on each communication device. Moreover, here, maintenance terminals MN410 to MN413 are directly connected to the communication devices NE203 to NE206, respectively, and each maintenance terminal has a function of individually monitoring and maintaining its corresponding communication device. There is a difference between the maintenance terminal and NMS in that NMS monitors and maintains the devices in the entire network from a remote site through the management links, while the maintenance terminal is directly connected to a communication device and individually monitors and maintains the communication device.

### 2.2) Communication Device

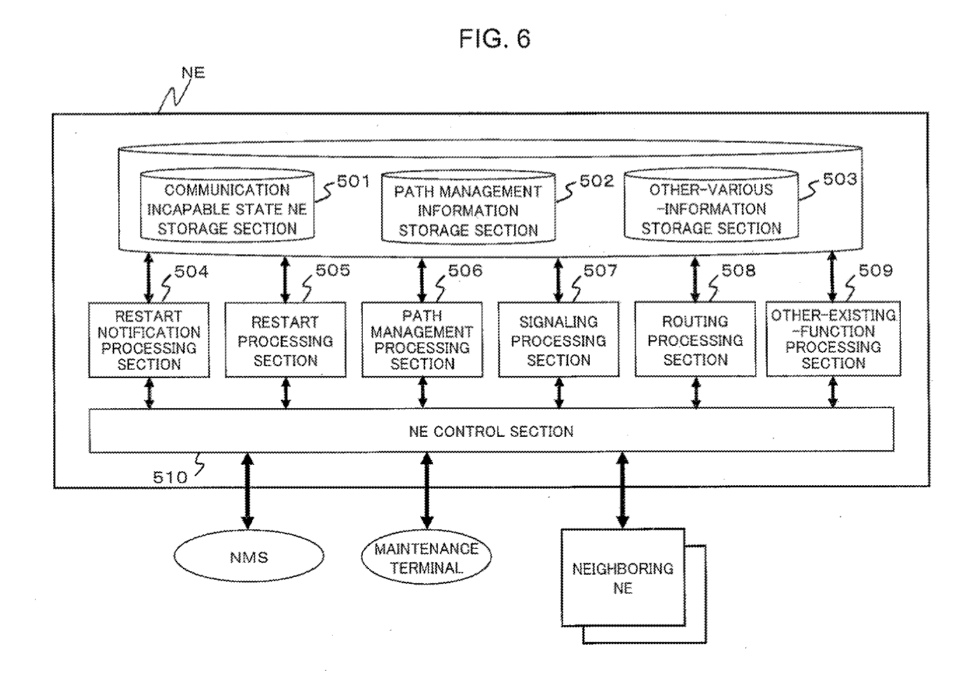

The communication devices (NE200 to NE206) according to the first example of the present invention basically have the same block configurations. Therefore, FIG. 6 shows the configuration of an arbitrary communication device NE.

Referring to FIG. 6, it is assumed that the communication device NE is connected to a neighboring communication device NE through the communication link 301 and control message exchange link 302, connected to the network management system NMS through the management link, and here further directly connected to the maintenance terminal MN.

The communication device NE is provided with a communication incapable state NE storage section 501, a path management information storage section 502, and other-various-information storage section 503 and further provided with a restart notification processing section 504, a restart processing section 505, a path management processing section 506, a signaling processing section 507, a routing processing section 508, and an other-existing-function processing section 509. A NE control section 510 controls these sections, whereby under-mentioned path setup control according to the present example is executed.

The communication incapable state NE storage section 501 stores the address of a neighboring NE in a state incapable of communication (in the present example, under restart).

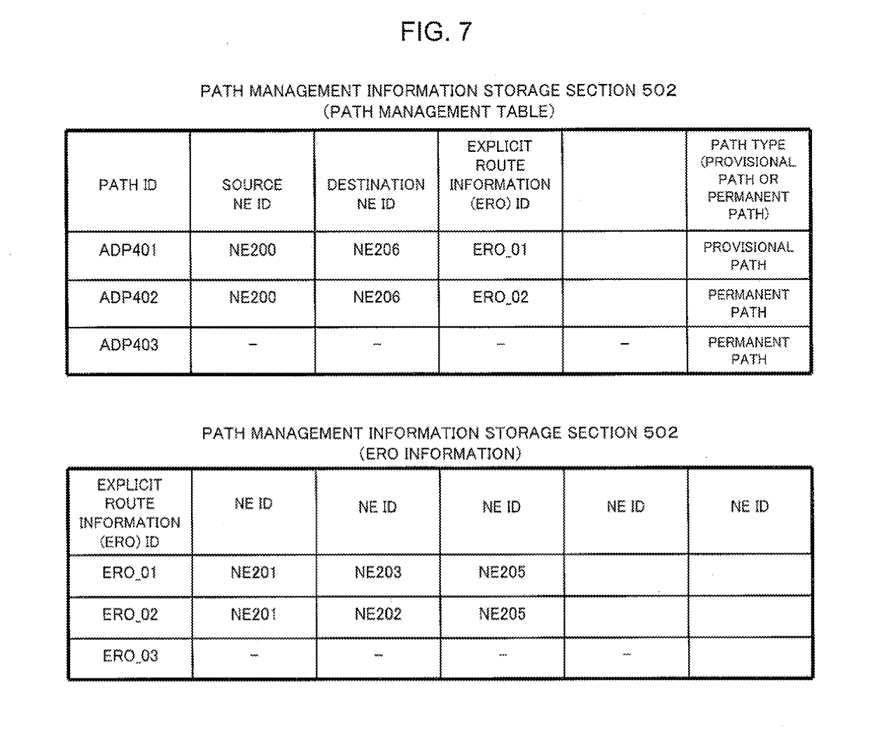

The path management information storage section 502 stores information on an autonomous distributed control path passing through its own communication device. Specifically, the path management information storage section 502 stores, for the path ID of each autonomous distributed control path, address information on a starting point communication device and an ending point communication device (source ID, destination ID), explicit route information (ERO: Explicit Route Object) between the starting point and ending point, and a path type indicating a permanent path or provisional path, as shown in FIG. 7.

The other-various-information storage section 503 stores various information other than the information stored in the path management information storage section 502 and communication incapable state NE storage section 501.

The restart notification processing section 504 has a function of notifying the neighboring communication device NE of a restart initiation notification and a restart completion notification. The restart processing section 505 has a function of restarting the communication device NE. The path management processing section 506 has a function of managing a path by using the path management information storage section 502, which will be described later. The signaling processing section 507 has a function of sending and receiving a signaling message for setting up/maintaining/disconnecting an autonomous distributed control path according to GMPLS/ASON or the like. The routing processing section 508 has a function of exchanging link information and computing a route. The other-existing-function processing section 509 has functions other than the above-described functions that a general ASON/GMPLS autonomous distributed control communication device has. The NE control section 510 has a control function to sort massages from the NMS and maintenance terminal and deliver processing messages.

Note that functions equivalent to the restart notification processing section 504, restart processing section 505, path management processing section 506, signaling processing section 507, routing processing section 508, other existing function processing section 509, and NE control section 510 can also be implemented by executing programs stored in a storage medium on a program-controlled processor such as a CPU.

### 2.3) Path Setup Signaling Exchange

As shown in FIG. 7, a path management table is stored in the path management information storage section 502, and information on a path that has been set up passing through its own communication device NE is managed. For example, taking the communication device NE201 in the present example as an example, a path of the path ID=ADP401 indicates that it is a provisional path having a starting point node of NE200, an ending point node of NE206, and explicit route information ERO of NE201-NE203-NE205. Moreover, a path of the path=ADP402 indicates that it is a permanent path having a starting point node of NE200, an ending point node of NE206, and explicit route information ERO_02 of NE201-NE202-NE205. Information on a permanent path can be obtained by receiving a path setup signaling message or path setup request, and information on a provisional path can be obtained by converting a received path setup signaling message or path setup request as will be described next.

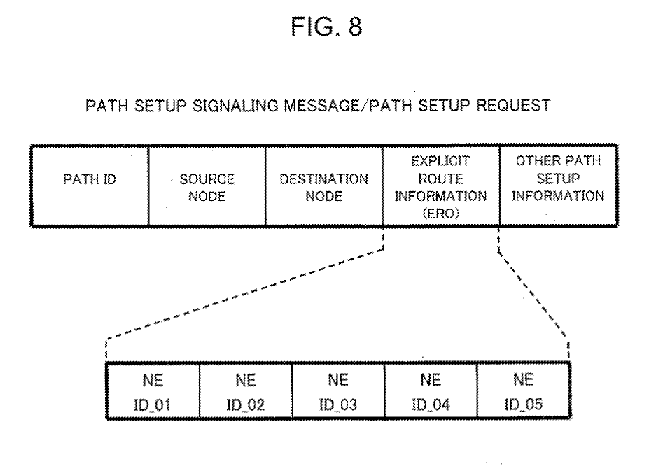

As shown in FIG. 8, a path setup signaling message or path setup request generally contains a path ID, a source node address, a destination node address, explicit route information ERO, and other setup information. In the explicit route information ERO, information about nodes (communication device IDs) to be included in a path in question is sequentially recorded.

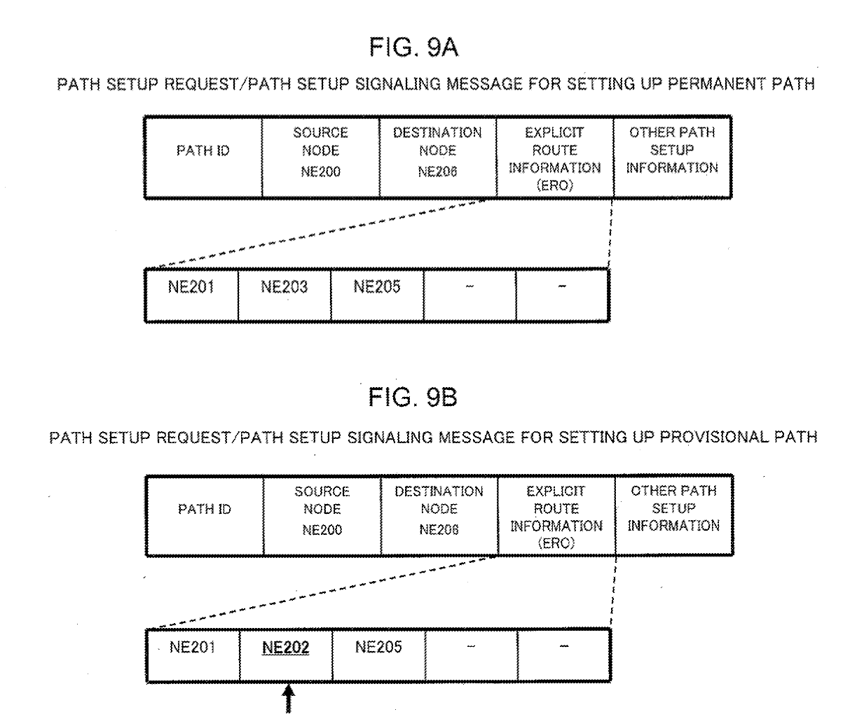

The path setup signaling message or path setup request for setting up the permanent path in the present example contains explicit route information ERO indicating the communication devices NE201-NE203-NE205, as shown in FIG. 9A. Moreover, the provisional path setup signaling message or path setup request in the present example contains explicit route information ERO indicating the communication devices NE201-NE202-NE205, as shown in FIG. 9B. That is, upon receipt of the path setup signaling message shown in FIG. 9A, the communication device NE201 according to the present example, if NE203 included in ERO of this message is restarting and is incapable of communication, generates a provisional path setup signaling message in which NE203 in ERO has been changed to NE202 as shown in FIG. 9B. Then, this provisional path setup signaling message is sent not to NE203 but to NE202, whereby control is performed so as to set up a provisional path detouring around NE203 in a state incapable of communication.

### 2.4) Path Setup Operation.

Hereinafter, assuming that the communication device NE203 restarts as described with FIGS. 2 to 4, a detailed description will be given of an example in which an attempt is made to set up an autonomous distributed control path along a route of NE200-NE201-NE203-NE205-NE206 while NE203 is restarting. Note that each of the communication devices NE200 to NE206 is assumed to have the block configuration shown in FIG. 6.

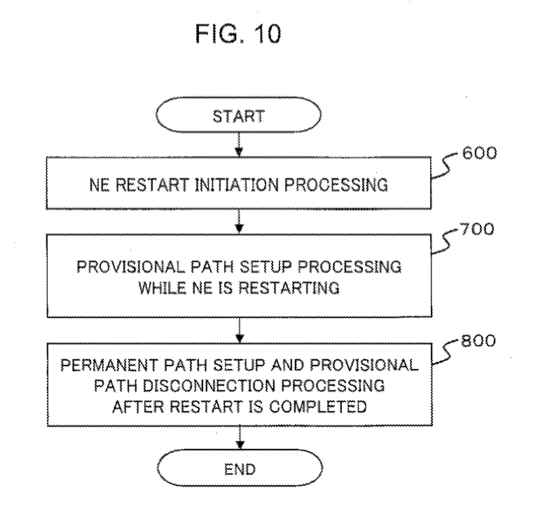

Referring to FIG. 10, a path setup operation according to the present example broadly includes NE restart initiation processing 600 (see FIG. 2A), provisional path setup processing 700 performed while NE is restarting (see FIG. 2B), and permanent path setup and provisional path disconnection processing 800 performed after restart is completed (see FIGS. 3 and 4). Hereinafter, these processings will be described in order.

### (a) NE Restart Initiation Processing

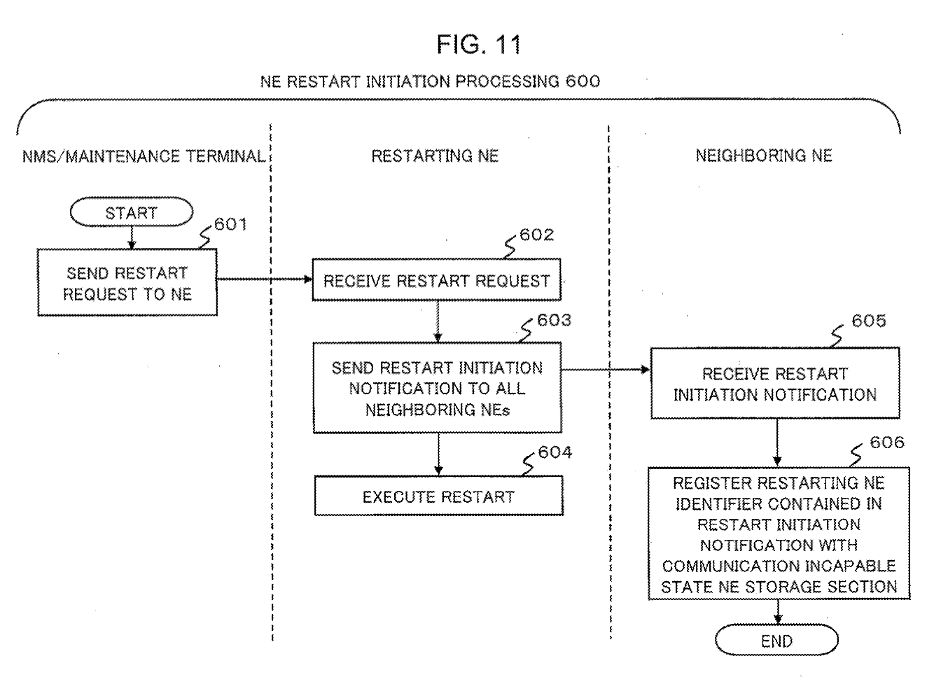

As shown in FIG. 11, the NE restart initiation processing 600 is performed by the NMS/maintenance terminal, communication device that restarts (restarting NE), and its neighboring communication device (neighboring NE). Hereinafter, processing at each step will be described.

Step 601: The NMS or maintenance terminal sends a restart request to the restarting NE203, which is a restart target.

Step 602: The NE control section 510 of the restarting NE203 receives the restart request from the NMS or maintenance terminal.

Step 603: The restart notification processing section 504 of the restarting NE203 sends a restart initiation notification to all neighboring communication devices (neighboring NEs). The restart initiation notification contains the identifier of this restarting NE203.

Step 604: The restart processing section 505 of the restarting NE203 executes restart processing for its own device.

Step 605: The restart notification processing section 504 of each neighboring NE receives the restart initiation notification.

Step 606: The restart notification processing section 504 of each neighboring NE stores the identifier of the restarting NE203 contained in the restart initiation notification into the communication incapable state NE storage section 501.

Through the above-described steps, each of the neighboring communication devices NE201, NE202, NE204, and NE205 recognizes that the communication device NE203 that has initiated restarting is in a state incapable of communication, as described with FIG. 2A.

### (b) Provisional Path Setup Processing Performed While NE is Restarting

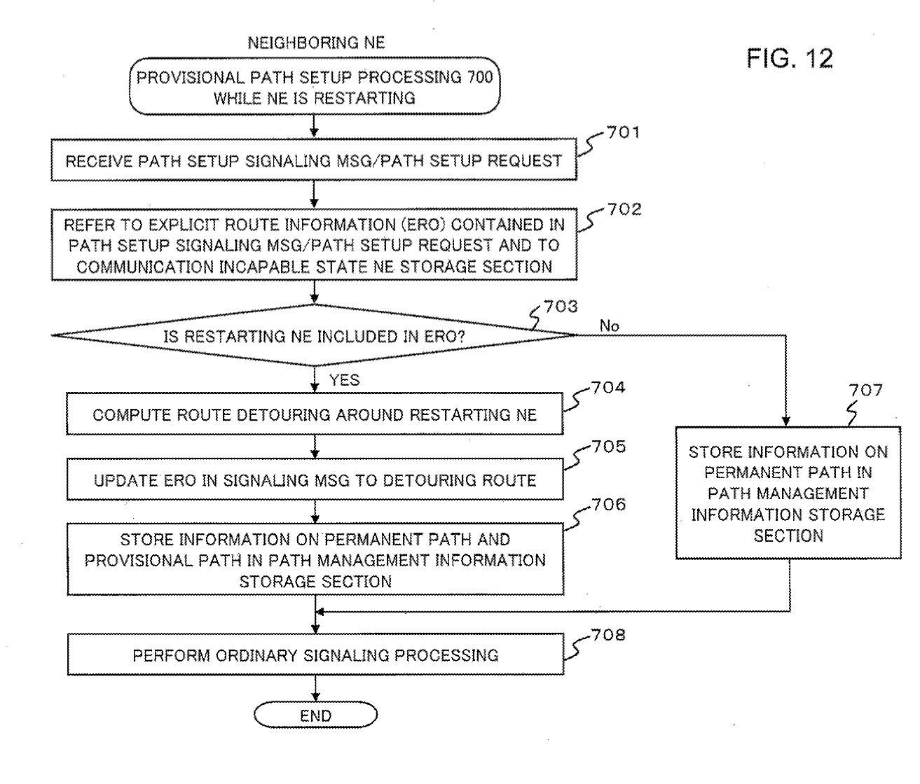

As shown in FIG. 12, the provisional path setup processing 700 while NE is restarting is performed by a neighboring NE (here, NE201) that has received path setup signaling. Hereinafter, processing at each step will be described.

Step 701: Path setup signaling is received from the communication device NE200. Although path setup is initiated by receiving path setup signaling from NE200 here, there also is a case where path setup is initiated by receiving a path setup request from the NMS or maintenance terminal. The path setup request and path setup signaling each contain explicit route information ERO as shown in FIG. 9A. The explicit route information ERO is information indicating the route of an autonomous distributed control path to be set up, in which the identifiers of communication devices or the identifiers of links along the route are concatenated.

Step 702: The signaling processing section 507 refers to the explicit route information ERO contained in the path setup request or path setup signaling and to the contents stored in the communication incapable state NE storage section 501.

Step 703: The signaling processing section 507 determines whether or not the restarting NE203 is included in the explicit route information ERO.

Step 704: If the restarting NE203 is included in the explicit route information ERO (Step 703: YES), the routing processing section 508 computes a route (NE200-NE201-NE202-NE205-NE206) detouring around the restarting NE203.

Step 705: The signaling processing section 507 updates the explicit route information ERO contained in the signaling message to the route (NE200-NE201-NE202-NE205-NE206) computed at Step 704 as described above (conversion from FIG. 9A to FIG. 9B).

Step 706: The path management processing section 506 stores information about the permanent path and provisional path in the path management table of the path management information storage section 502. The permanent path is the path originally planned to be set up, and the provisional path is the path detouring around the restarting NE203 and ranks as a path provisionally substituting for the originally planned permanent path. Information about a path type for identifying whether the entry of each path is a permanent path or a provisional path is also stored in the path management information storage section 502 (see FIG. 7).

Step 707: If the restarting NE203 is not included in the explicit route information ERO (Step 703: NO), the path management processing section 506 stores information on the permanent path in the path management information storage section 502.

Step 700: The signaling processing section 507 performs ordinary signaling processing.

Through the above-described steps, the communication device NE201 sets up the provisional path P2 in place of the permanent path P1 as shown in FIG. 2B, and thereafter data between the communication devices NE200 and NE206 is transferred by using the provisional path P2 until the restarting NE203 recovers.

### (c) Permanent Path Setup and Provisional Path Disconnection Processing

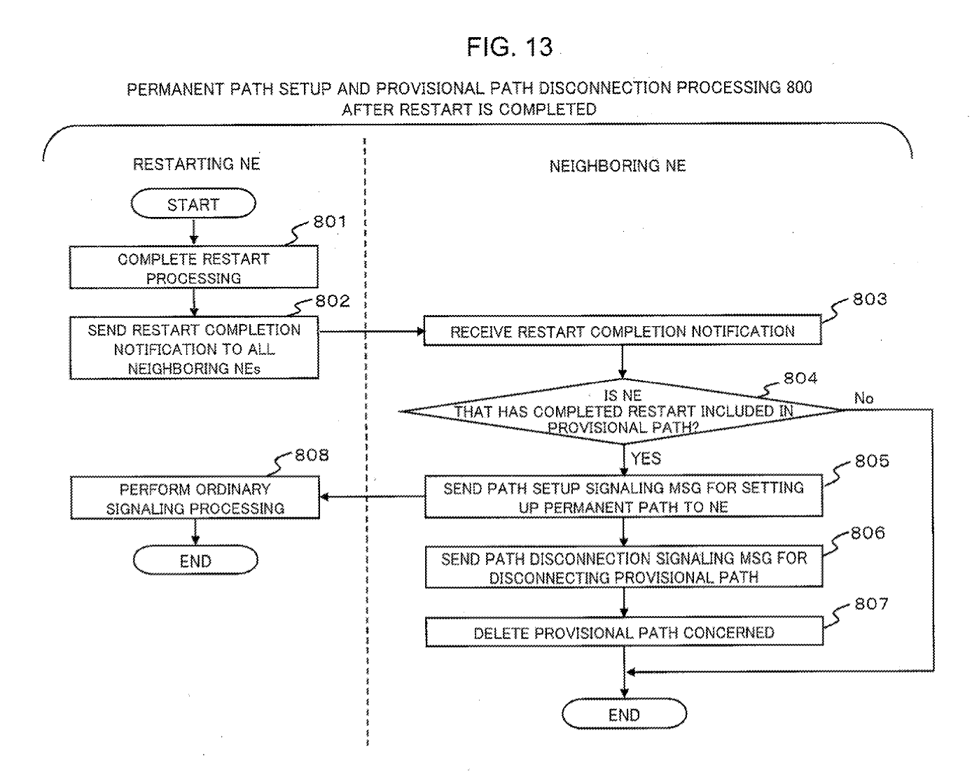

As shown in FIG. 13, the permanent path setup and provisional path disconnection processing 800 performed after the restarting NE has completed restart is performed by the restarting NE and neighboring NE (here, NE201). Hereinafter, processing at each step will be described.

Step 801: The restarting NE203 has completed restart processing.

Step 802: The restart notification processing section 504 of the restarting NE203 sends a restart completion notification to all the neighboring communication devices (neighboring NEs). The restart completion notification contains the identifier NE-ID of this restarting NE.

Step 803: The NE control section 510 of the neighboring NE201 receives the restart completion notification from the restarting NE.

Step, 804: The path management processing section 506 of the neighboring NE201 determines whether or not NE-ID contained in the restart completion notification is included in ERO of the provisional path stored in the path management information storage section 502.

Step 805: If NE-ID contained in the restart completion notification is included in the provisional path (Step 804: YES), the signaling processing section 507 of the neighboring NE201 sends a path setup signaling message for setting up the permanent path corresponding to the provisional path concerned to the restarting NE203. Note that if NE-ID contained in the restart completion notification is not included in the provisional path (Step 804: NO), the neighboring NE201 finishes without performing any processing.

Step 806: The signaling processing section 507 of the neighboring NE201 sends a path disconnection signaling message for disconnecting the provisional path (here, to the communication device NE202).

Step 807: The path management processing section 506 of the neighboring NE201 deletes the entry of the provisional path in question in the path management information storage section 502.

Step 808: The restarting NE203 that has received the path setup signaling performs ordinary path setup signaling processing according to an autonomous distributed control protocol such as GMPLS/ASON.

Note that a maintainer can set a provisional path setup timer on a communication device NE via the NMS or maintenance terminal. A set value of the provisional path setup timer represents a period of time for which a communication device neighboring to a restarting NE leaves the provisional path set up. When the provisional path setup timer expires, this communication device notifies the maintainer of the time-out and also disconnects the provisional path. Since the provisional path ranks as a path provisionally substituting the originally planned permanent path, it is preferable to provide such a provisional path setup timer.

### 2.5) Effects

As described above, according to the path setup method of the first example of the present invention; a restarting NE notifies its restart to a neighboring NE, and the neighboring NE detours a path setup signaling message passing through the restarting NE, thereby setting up a provisional path. Thus, in a network based on autonomous distributed control such as GMPLS/ASON, even if a communication device existing in the route of a path restarts when setting up the path, it is possible to avoid a failure in path setup resulting in termination.

Moreover, the restarting NE notifies the completion of restart to the neighboring NE, and the neighboring NE sets up the permanent path and at the same time disconnects the provisional path. Thus, in a network based on autonomous distributed control such as GMPLS/ASON, it is possible to set up a path along an originally intended route after restart is completed.

### 3. Second Example

The above-described first example illustrates the path setup operation performed when a restart request is explicitly issued from the NMS or maintenance terminal. However, the present invention is not limited to this example. It is possible to prevent a failure in path setup even when a fault occurs in a communication device or in a control channel.

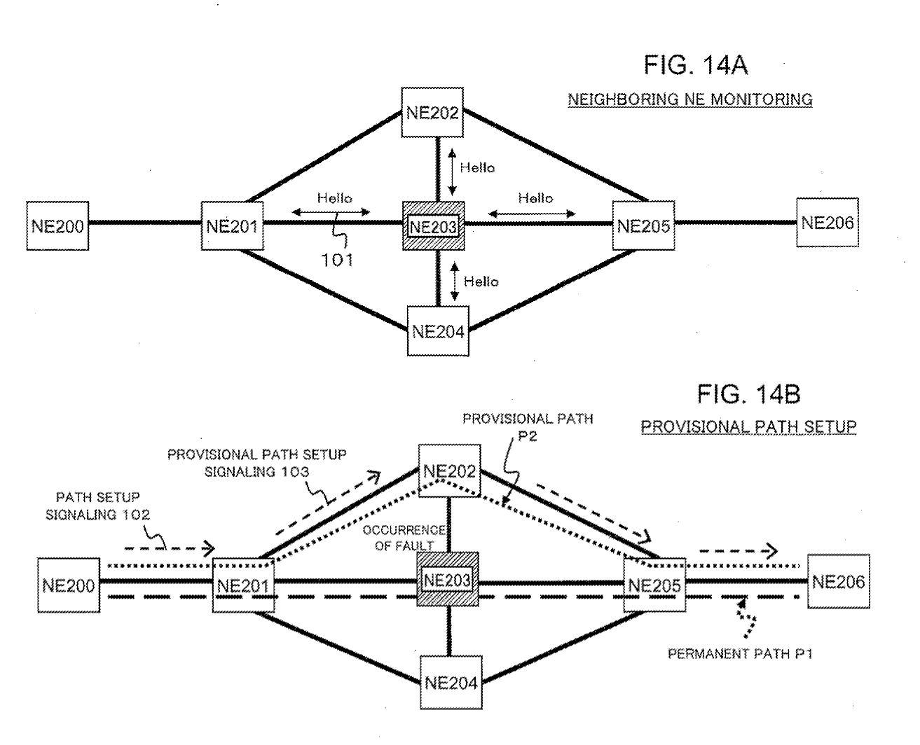

As shown in FIG. 14A, communication devices supporting autonomous distributed control such as GMPLS/ASON generally exchange a Hello message with neighboring communication devices, thereby checking their existences with each other. Since this Hello message cannot be received when a fault has occurred in a communication device or in a control channel, it can be recognized that some abnormality has occurred with a neighboring communication device.

Accordingly, for example, when the communication device NE201 does not receive a Hello message from the communication device NE203, the communication device NE201 can treat the communication device NE203 like a restarting communication device in a state incapable of communication in the first example That is, the communication device NE203 from which a Hello message is not received is registered with the communication incapable state NE storage section 501. In this state, when the path setup signaling message 102 for setting up the permanent path P1 passing through the communication device NE203 is received from the communication device NE200, the communication device NE201 sends the provisional path setup signaling message 103 to the communication device NE202 as described above, whereby it is possible to set up the provisional path P2 as shown in FIG. 14B.

Thus, even if a fault or the like has occurred with the communication device NE203 existing in the route of the original path attempted to be set up and the communication device NE203 is in a state incapable of communication, the provisional path P2 is set up, whereby it is possible to prevent a failure in the path setup initiated by the path setup signaling 102.

When the communication device NE203 recovers after the provisional path P2 is set up, the communication device NE201 receives a Hello message from the communication device NE203 and therefore can recognize that the communication device NE203 has recovered. When finding that the communication device NE203 has recovered, the communication device NE201 initiates an operation for setting up the original permanent path P1 and disconnecting the provisional path P2 as described with FIG. 4. Thus, even if a communication device existing in a path to be set up is incapable of communication due to the occurrence of a fault, it is possible to avoid a failure in path setup, and it is possible to return to the original path when a recovery from the fault is made.

Note that when the communication device NE203 recovers after the provisional path P2 is set up, it is also possible that the communication device NE203 that has recovered sends a recovery message to all neighboring communication devices.

As descried above, according to the path setup method of the second example of the present invention, in a network based on autonomous distributed control such as GMPLS/ASON, even if a fault occurs in a communication device existing in the route of a path or occurs in a communication channel to the communication device when setting up the path, a failure in path setup resulting in termination can be avoided by setting up a provisional path. Moreover, when the communication device with which a fault occurred has recovered from the fault, a neighboring communication device sets up the permanent path and at the same time disconnects the provisional path. Therefore, it is possible to set up a path along an originally planned route upon recovery from a fault.

### INDUSTRIAL APPLICABILITY

The prevent invention can be applied to path setup control in an autonomous distributed control-based network of any type in which a plurality of nodes or communication devices are connected.

### [Reference Signs List]

101 Restart initiation notification
102 Path setup signaling message
103 Provisional path setup signaling message
110 Restart completion notification
111 Permanent path setup signaling message
112 Provisional path disconnection signaling message
NE200 to NE206 Communication device (node)
P1 Permanent path
P2 Provisional path

1. A method for setting up a path through autonomous distributed control in a network in which a plurality of communication devices are connected, comprising:
by a communication device, determining whether or not it is possible to communicate with a neighboring communication device neighboring to the communication device; and
by a communication device, when it is impossible to communicate with the neighboring communication device, converting signaling for setting up a path passing through the neighboring communication device into signaling for setting up a provisional path detouring around the neighboring communication device.

2. The method for setting up a path according to claim 1, wherein when it becomes possible to communicate with the neighboring communication device, signaling for disconnecting the provisional path and signaling for setting up the path passing through the neighboring communication device are executed.

3. The method for setting up a path according to claim 1, wherein when a restart initiation notification is received from the neighboring communication device, it is determined that it is impossible to communicate with the neighboring communication device.

4. The method for setting up a path according to claim 3, wherein when a restart completion notification is received from the neighboring communication device, it is determined that it becomes possible to communicate with the neighboring communication device.

5. The method for setting up a path according to claim 1, wherein depending on presence or absence of a check message periodically received from the neighboring communication device, it is determined whether or not it is possible to communicate with the neighboring communication device.

6. The method for setting up a path according to claim 1, wherein the network is an autonomous distributed control-based network complying with MPLS (Multi-Protocol Label Switching), GMPLS (Generalized MPLS), or ASON (Automatically Switched Optical Network) to which GMPLS is applied.

7. A communication device which is connected to a plurality of neighboring communication devices and has a function of setting up a path through autonomous distributed control, comprising:
a determination section that determines whether or not it is possible to communicate with a neighboring communication device; and
a signaling conversion section that, when it is impossible to communicate with the neighboring communication device, converts signaling for setting up a path passing through the neighboring communication device into signaling for setting up a provisional path detouring around the neighboring communication device.

8. The communication device according to claim 7, further comprising a signaling processing section that executes signaling for disconnecting the provisional path and signaling for setting up the path passing through the neighboring communication device when it becomes possible to communicate with the neighboring communication device.

9. The communication device according to claim 7, wherein when a restart initiation notification is received from the neighboring communication device, the determination section determines that it is impossible to communicate with the neighboring communication device.

10. The communication device according to claim 9, wherein when a restart completion notification is received from the neighboring communication device, the determination section determines that it becomes possible to communicate with the neighboring communication device.

11. The communication device according to claim 7, wherein depending on presence or absence of a check message periodically received from the neighboring communication device, the determination section determines whether or not it is possible to communicate with the neighboring communication device.

12. The communication device according to claim 7, wherein the communication device is connected to an autonomous distributed control-based network complying with MPLS (Multi-Protocol Label Switching), GMPLS (Generalized MPLS), or ASON (Automatically Switched Optical Network) to which GMPLS is applied.

13. A system for setting up a path through autonomous distributed control in a network in which a plurality of communication devices are connected, wherein
each of the plurality of communication devices comprises:
a determination section that determines whether or not it is possible to communicate with a neighboring communication device; and
a signaling conversion section that, when it is impossible to communicate with the neighboring communication device, converts signaling for setting up a path passing through the neighboring communication device into signaling for setting up a provisional path detouring around the neighboring communication device.

14. The system for setting up a path according to claim 13, wherein each of the communication devices further comprises a signaling processing section that executes signaling for disconnecting the provisional path and signaling for setting up the path passing through the neighboring communication device when it becomes possible to communicate with the neighboring communication device.

15. The system for setting up a path according to claim 13, wherein when a restart initiation notification is received from the neighboring communication device, the determination section determines that it is impossible to communicate with the neighboring communication device.

16. The system for setting up a path according to claim 15, wherein when a restart completion notification is received from the neighboring communication device, the determination section determines that it becomes possible to communicate with the neighboring communication device.

17. The system for setting up a path according to claim 13, wherein depending on presence or absence of a check message periodically received from the neighboring communication device, the determination section determines whether or not it is possible to communicate with the neighboring communication device.

18. The system for setting up a path according to claim 13, wherein the network is an autonomous distributed control-based network complying with MPLS (Multi-Protocol Label Switching), GMPLS (Generalized MPLS), or ASON (Automatically Switched Optical Network) to which GMPLS is applied.

19. (canceled)

20. (canceled)

21. (canceled)

22. (canceled)

23. (canceled)
